(19) United States
(12) Patent Application Publication
(10) Pub. No.: US 2012/0089411 A1
(43) Pub. Date: Apr. 12, 2012

(54) STANDARD-COMPLIANT LABEL AND METHOD OF PROVIDING A STANDARD COMPLIANT LABEL

(75) Inventors: Lawrence Srnka, Northfield Center, OH (US); Peter O. Botten, Lakewood, OH (US)

(73) Assignee: CODONICS, INC., Middleburg Heights, OH (US)

(21) Appl. No.: 12/901,110

(22) Filed: Oct. 8, 2010

(51) Int. Cl. G06Q 50/00; G09F 3/10; G06K 15/02; G06Q 10/00

(52) U.S. Cl. 705/2; 40/638; 358/1.6; 358/1.18

(57) ABSTRACT

Provided is a label generated on-demand for identifying a medicinal substance to be administered to a patient. The label includes a content surface on which label content is printed on-demand by a computer printer. The label content includes information required by a medical labeling standard. An adhesive surface is provided to be applied against a container for storing the medicinal substance and adhering the label to the container. A color code is visible when viewing the content surface. The color code is specified by the medical labeling standard for conveying information about the medicinal substance to be stored in the container, and the label content and color code render the label compliant with the medical labeling standard.

### BACKGROUND OF THE INVENTION

1. Field of the Invention

This application relates generally to a standard-compliant label and, more specifically, to a method of providing a label on-demand that is compliant with a medical labeling standard.

2. Description of Related Art

Conventional labeling systems suffer from many drawbacks, and have limited reliability due primarily to human error. Sloppy handwriting can make the label difficult to read, or altogether illegible. Each technician who prepares such a label may also do so in a different manner, or attribute different meanings to the content of a label than another technician. In such situations, the label content is left open to interpretation, and often lacks information essential for proper documentation and record keeping purposes.

Also, in sterile environments the technicians involved in preparing a syringe and corresponding label may also be wearing sterile medical garments. It is desirable to minimize contact with objects that may not be sterile, but the conventional labeling methods require the technician to physically interact with the labels, pen and their respective packages.

### BRIEF SUMMARY

Accordingly, there is a need in the art for a label that is compliant with a medical labeling standard, and a method of providing such a label on demand.

According to one aspect, the subject application involves a method of providing a label for a medicinal or other substance in the medical field. The method includes receiving an identification of the medicinal substance entered via a computer-input peripheral. Based on the identification of the medicinal substance received, selecting at least one requirement mandated by a labeling standard such as a color code associated with the medicinal substance, a font to be used for label content, any other requirement of the labeling standard, or any combination thereof. And, with a computer printer, printing label content on demand, the label content optionally comprising at least one of a name of the medicinal substance on a label stock and a color code to produce a color-coded label for the medicinal substance, said label being compliant with a labeling standard governing at least one aspect of a label employed in a medical application.

According to another aspect, the subject application involves a computer terminal for generating a label for identifying a medicinal substance to be administered to a patient. The computer terminal includes a processor; a computer-input peripheral for entry of an identification of the medicinal substance; a printer for printing label content on the label; and a non-transitory computer-readable medium storing computer-executable instructions that, when executed, control the terminal in performing a method. The method includes receiving the identification of the medicinal substance entered via the computer-input peripheral. Based on the identification of the medicinal substance received, a color code for the medicinal substance is selected in compliance with a medicinal substance labeling standard. With the printer, label content that is required by the medicinal substance labeling standard is printed. The label content includes at least a name of the medicinal substance on label stock to produce a color-coded label for the medicinal substance, said color-coded label being compliant with the medicinal substance labeling standard.

According to another aspect, the subject application involves a healthcare facility that includes a substantially sterile environment in which a medical procedure is to be performed on a patient. A computer terminal is provided for generating a label for a medicinal substance to be administered to the patient, or for labeling any other object or substance involved in a medical application. The terminal includes a processor, a computer-input peripheral for entry of an identification of the medicinal substance, a printer for printing label content on the label, and a non-transitory computer-readable medium storing computer-executable instructions that, when executed, control the terminal in performing a method. The method includes receiving the identification of the medicinal substance entered via the computer-input peripheral. Based on the identification of the medicinal substance received, a color code for the medicinal substance is selected in compliance with a medicinal substance labeling standard. With the printer, label content that is required by the medicinal substance labeling standard is printed. The label content includes at least a name of the medicinal substance on label stock to produce a color-coded label for the medicinal substance. The color-coded label is compliant with the medicinal substance labeling standard.

According to another aspect, the subject application involves a label generated on-demand for identifying a medicinal substance to be administered to a patient. The label includes a content surface on which label content is printed on-demand by a computer printer. The label content includes information required by a medical labeling standard. An adhesive surface is provided to be applied against a container for storing the medicinal substance and adhering the label to the container. A color code is visible when viewing the content surface. The color code is specified by the medical labeling standard for conveying information about the medicinal substance to be stored in the container, and the label content and color code render the label compliant with the medical labeling standard.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of a computer terminal for producing, on demand, a label that is compliant with a medical labeling standard;

FIG. 2 shows a block diagram illustrating components of the computer terminal shown in FIG. 1;

FIG. 3 shows an illustrative embodiment of a label that complies with a medical labeling standard;

FIG. 4 shows an illustrative embodiment of a syringe provided with a label that is compliant with a medicinal labeling standard; and

FIG. 5 shows a flow diagram schematically depicting an embodiment of a method of producing a label that complies with a medicinal labeling standard.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

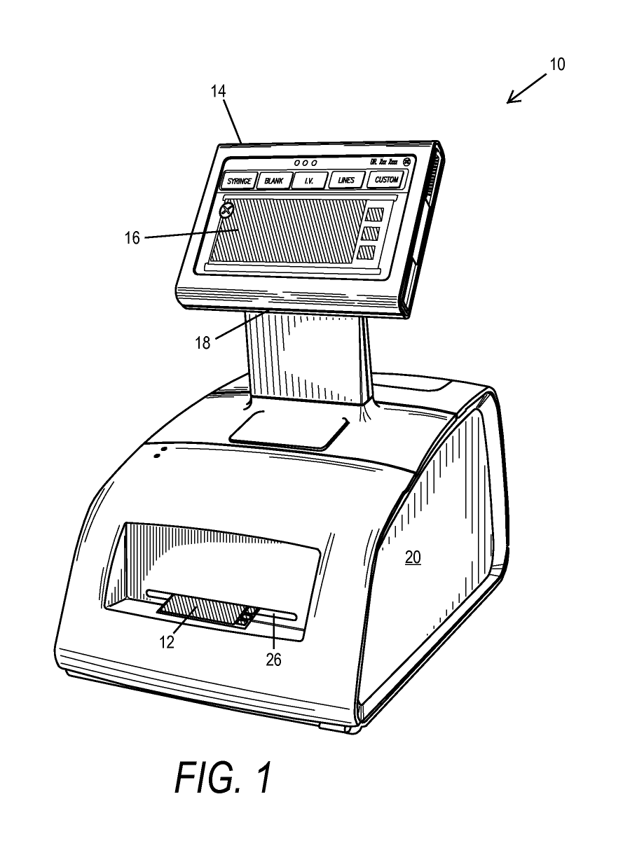

FIG. 1 shows an illustrative embodiment of a computer terminal 10 for generating a label 12 for identifying a medicinal substance to be administered to a patient, a tissue sample, a medical device, a solvent, or any other material encountered in a medical application. The medical application can be considered any activity, object or substance relating to, or otherwise involved in the provision of medical treatment, healthcare, and the performance of any activity in the life sciences. However, for the sake of brevity, the labeling of a medicinal substance is described in the examples below. The invention is not limited to the labeling of a medicinal substance according to a medicinal substance labeling standard, but encompasses the labeling of any material encountered in the medical field according to a standard observed in the medical field governing the labeling of that material.

As shown in FIG. 1, the computer terminal 10 includes a touch-screen display 14 that displays a virtual label 16 to be printed as the label 12, and displays soft keys that can be touched by a technician or any user to input data and commands into the computer terminal 10. The virtual label 16 is a computer-generated rendering of the label 12 that offers the user visual confirmation of the appearance of the physical label 12 to be printed by a printer 26. A computer-input peripheral such as a contactless scanner 18 can be provided at a convenient location such as adjacent a bottom portion of the display 14 to read a machine-readable code. For example, the computer-input peripheral can be a barcode reader or radio-frequency identification (“RFID”) tag reader, or any other device that reads a machine-readable code such as a barcode or RFID code, respectively, or any other machine-readable code without requiring contact between the computer terminal and the code, and optionally the user during entry of the code. According to alternate embodiments, the display 14 can be utilized by a user as the computer-input peripheral. For such embodiments, the soft keys displayed by the display 14 can be selected to input information such as a medicinal substance being prepared to be administered to a patient or other information to be utilized in generating the label as described herein.

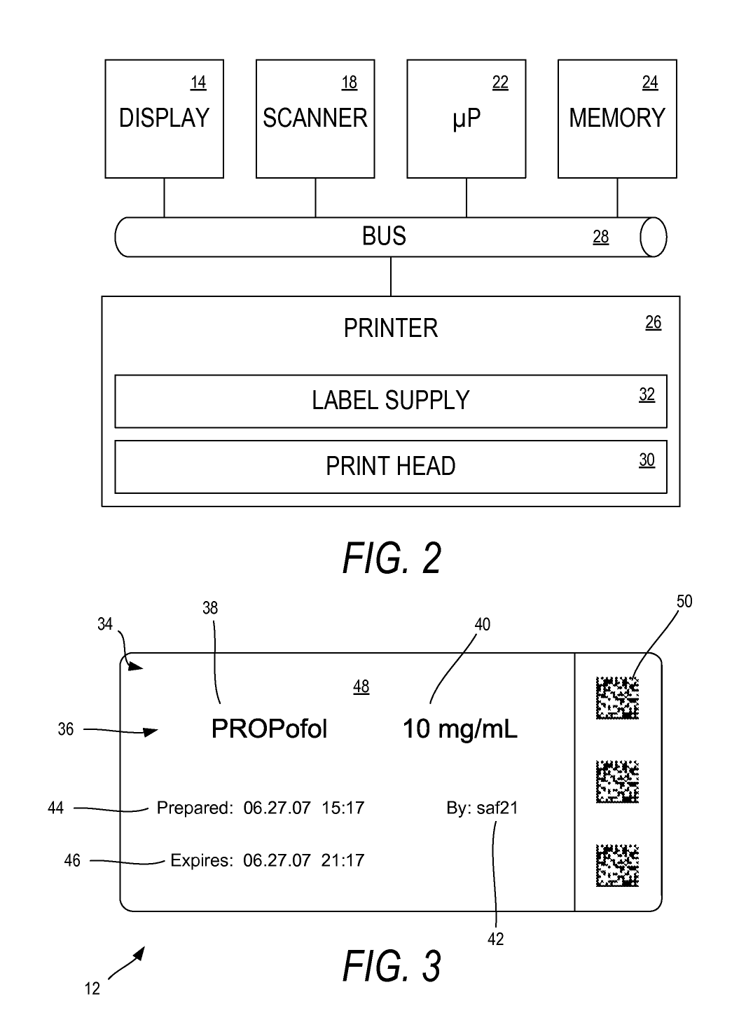

The computer terminal 10 also includes a cabinet 20 housing components that are operable to produce the label 12 in compliance with a medical labeling standard. But again, if what is being labeled is anything other than the medicinal substance, then the label 12 produced is to be compliant with a standard developed by a trade or professional organization, governing body, government agency, a healthcare provider or facility such as a hospital, or any other standards body setting forth policies for labeling such material. The cabinet 20 can also support the display 14 and the scanner 18 to form a self-contained, stand-alone unit. The internal components housed within the cabinet 20 are schematically illustrated by the block diagram of FIG. 2. A computer processor 22 is provided to execute computer-executable instructions stored in a non-transitory computer readable memory 24 such as a hard disk drive, read-only memory (“ROM”), random access memory (“RAM”), optical disc, or any other suitable memory device. The computer-executed instructions, when executed by the computer processor 22, result in the performance of the method of generating a label for a medicinal substance described in detail below. A bus system 28 facilitates communication between components such as the display 14, scanner 18, processor 22, memory 24 and printer 26.

The printer 26 includes a print head 30 for applying label content onto label stock delivered from a supply 32 of labels, which can be blank, or at least in partial compliance with a medical labeling standard. The print head 30 can fall within any category of printing technology suitable to apply label content onto label stock. For example, the print head 30 can be an inkjet print head that deposits droplets of ink in a pattern to create the label content, a laser print head that directs a laser across a photoreceptor to create the pattern for the label content to be printed, a solid-ink print head, a dot matrix print head, and the like.

The label supply 32 can include a roll of label stock that has blank labels supported on a release tape, a tray of individual blank labels, or any other source of labels on which label content is to be printed. The label supply 32 can be internally disposed within the printer 26 or fed into the printer from an external location.

The computer terminal 10 can optionally be deployed at a healthcare facility such as a hospital or surgical center, for example, where medicinal substances are prepared and administered to patients. An operating room, treatment room, or other facility including a sterile field that is a substantially-sterile environment can optionally be provided within the healthcare facility, and the computer terminal 10 disposed within, or immediately adjacent to such a sterile environment. According to such embodiments, the label can be generated as described in detail below within, or at least within a close proximity to the sterile environment, and applied to the syringe, vial or other container in which the medicinal substance is to be contained with minimal exposure to other environments that are not sterile.

FIG. 3 shows an illustrative embodiment of a label 12 to be generated by the computer terminal 10. The label 12, as shown, includes label content that is compliant with, and renders the label 12 compliant with a medical substance labeling standard. For example, the medicinal substance labeling standard can be the guidelines promulgated by the National Safety Patient Goals of the Joint Commission, the American Society of Anesthesiologists, any other medicinal labeling standard established by a professional governing or trade organization or a governmental organization, or any combination thereof. Such guidelines can be based on other medicinal substance labeling standards such as those created by ASTM International, for example. The medicinal substance labeling standards can also require specific sizes, colors and patterns, type faces and other label content used on labels applied to unlabeled syringes that are filled by the users (i.e., those who will administer the medicinal substance to the patient) or their agents to identify the medicinal substance. Such standards are typically not intended to govern the requirements of labels applied by the drug manufacturer.

The label content required to render the label 12 compliant with a labeling standard created to govern the labeling of any material in the medical field can be specific to the particular standard against which compliance is to be measured. For instance, depending on the medicinal substance labeling standard, the label content can include one, a plurality, or all of the following:

a concentration of a medicinal substance to be identified by the label 12,

a dilution of a medicinal substance and a diluent used to dilute the medicinal substance;

a date and/or time on which the medicinal or other substance in the medical field to be labeled was prepared

an expiration date and/or time of the medicinal or other substance to be labeled;

an identification of an individual who prepared the medical substance to be labeled;

a warning about a risk associated with the medicinal substance; and

a color to be applied to the label 12 as required by the medicinal substance labeling standard for the particular medicinal substance to be labeled.

For the illustrative embodiment of the label 12 shown in FIG. 3, the label content 36 is applied by the printer 26 to a content surface 34 of the label 12 that is exposed and viewable when the label 12 is applied to the syringe or other container. An adhesive surface (opposite the content surface 34) can also be provided to be applied against a syringe or other container for storing the medicinal substance and adhere the label 12 to such syringe or other container. The label content is printed on-demand by the computer printer 26 under the control of the users who are involved in preparing the syringe or other container with the medical substance, administering the medicinal substance to the patient, or their agents. By “on demand” it is meant that the label is caused to be generated by the aforementioned users, as opposed to a drug manufacturer, at a time when the syringe or other container is being prepared with the medicinal substance to be labeled, or shortly before or after preparation of the syringe or other container with the medicinal substance to be labeled.

The illustrative embodiment of the label 12 in FIG. 3 is compliant with a medicinal substance labeling standard requiring the name 38 of the medicinal substance, which is Propofol in the present embodiment, along with a concentration 40 of the medicinal substance, which is 10 mg/mL. The name of the medicinal substance can be printed using so-called “tall man lettering” to help emphasize the difference between different medicinal substances with similar spellings. Tall man lettering requires printing a distinguishing portion of the name in all caps, and the remainder of the name in common with the distinguished medicinal substance in lower case letters. The label content 36 on the label 12 also includes the identity 42 of the person who prepared the label 12 and/or the syringe of the medicinal substance, along with the date and time 44 the syringe of the medicinal substance was prepared, and the expiration date and time 46 of that syringe of the medicinal substance.

The label 12 also includes a color code that is visible when viewing the content surface 34 of the label 12. For the illustrative embodiment in FIG. 3, the color code appears as a solid colored background 48 to printed text such as the name 38, concentration 40, identity 42 of the preparer, and preparation and expiration dates and times 44, 46. The color code is specified in this example by the medicinal substance labeling standard. For example, induction agents such as thiopental and ketamine are identified by a solid yellow color code. Tranquilizers such as diazepam and midazolam are identified by a solid orange color background. Narcotics such as morphine and fentanyl are identified by a solid blue color background. Antagonist medicinal substances are denoted by diagonal stripes of the agonist color alternating with white stripes.

The color code can optionally be printed onto the content surface 34 as label content 36 by the printer 26. According to alternate embodiments, the color code is pre-applied to the label 12 to be visible when viewing the content surface 34 by a manufacturer of the label stock before the label 12 is introduced to the printer 26. For such alternate embodiments, the appropriate pre-color-coded label stock is selected from among available label stock that is pre-color coded with a plurality of different colors. Each of the different colors corresponds to a different medicinal substance in accordance with the medicinal substance labeling standard. Thus, several rolls of different colored label stock may be available, and the appropriate roll having the color code corresponding to the medicinal substance to be labeled can be selected.

A machine-readable code 50 can also optionally be printed by the printer 26 as label content 36 on the label 12. The machine-readable code can be a barcode, RFID code, or other suitable code that is indicative of the medicinal substance being labeled. For instance, the machine-readable code 50 can represent the other label content 36, and optionally the color code, for integrating the labeling of the syringe or other container with an Anesthesiology Information Management System (“AIMS”) or other hospital information system.

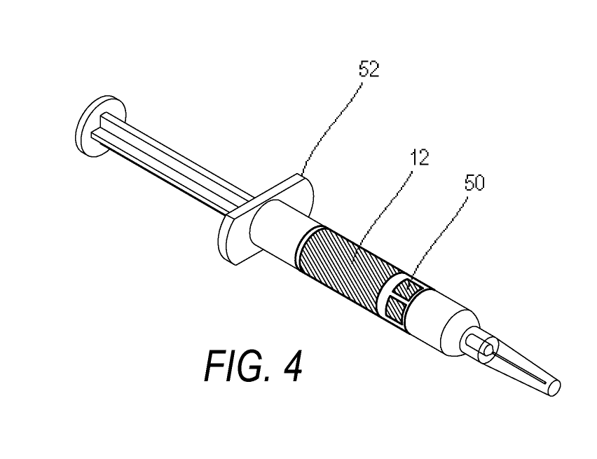

FIG. 4 shows an illustrative embodiment of a syringe 52 storing a medicinal substance that is labeled with a label 12 generated according to the method described herein. As shown, the label 12 bearing the machine-readable code 50 can be applied to the syringe 52 and, before administration of the medicinal substance, the machine-readable code 50 can be scanned by scanner 18 (FIG. 1) provided to the computer terminal 10. The computer terminal 10 can optionally display the virtual label 16, and optionally audibly announce the medicinal substance identified by the label 12 for confirmation purposes.

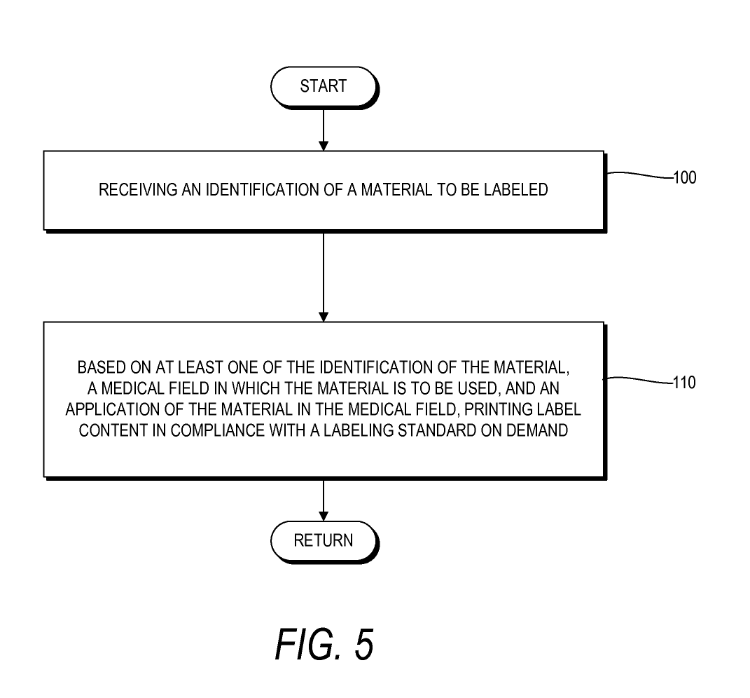

A method of providing a label for a medicinal substance is illustrated schematically in FIG. 5. The method includes receiving, at step 100, an identification of the medicinal substance entered via a computer-input peripheral such as the display 14, scanner 18, or a combination thereof. According to one embodiment, a vial from which the medicinal substance is to be extracted into a syringe 52 is also labeled with a barcode or other machine-readable code identifying the medicinal substance. That barcode can be scanned by the scanner 18 to automatically input into the computer terminal 10 information such as the name of the medicinal substance, concentration and preparation and expiration dates to be included in the label content 36. A machine-readable code on a badge worn by the user preparing the label and/or syringe can also be scanned by scanner 18 to input the identity of the person who is to appear as the preparer on the label 12.

Based on at least one of the identification of the medicinal substance received, a medical field in which the material is to be used, and an application of the material in the medical field, a color code for the medicinal substance is selected in compliance with a medicinal substance labeling standard and the label content, optionally including the color code, is printed in compliance with the medicinal substance labeling standard at step 110. For instance, Propofol is an induction agent, so the yellow color code can be selected according to one labeling standard. A lookup table storing relationships between the color code, text font, label size, and the various medicinal substances can be stored in the non-transitory computer-readable memory provided to the computer terminal 10.

In response to selection of the color code and/or receiving the identification of the material to be labeled, the printing on demand at step 110 can optionally occur automatically without operator intervention, with a computer printer. The label content can optionally comprise at least the name 38 (FIG. 3) of the medicinal substance on the content surface 34 of label stock to produce a color-coded label 12 for the medicinal substance that is compliant with the medicinal substance labeling standard.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of providing a label to be utilized in a medical application, the method comprising:
receiving an identification of a material to be labeled for use in the medical application;
based on the identification of the material to be labeled in the medical application received, printing label content to create the label in compliance with a labeling standard for use in the medical application;

2. The method of claim 1, wherein the label content is printed by a computer printer and further comprises a color corresponding to a color code mandated by the labeling standard, the color to be printed on label stock approximately at a time when the label content is printed.

3. The method of claim 1, wherein the label content is to be printed on label stock that is pre-color-coded with a color mandated by the labeling standard before the label content is printed, and the label content is printed on the label stock that is pre-color-coded.

4. The method of claim 3, wherein the color code is selected for the material by selecting the pre-color-coded label stock from among available label stock that is pre-color coded with a plurality of different colors, wherein each of the different colors corresponds to a different medicinal substance in accordance with the labeling standard.

5. The method according to claim 1, wherein said receiving the identification of the material to be labeled comprises:
reading, with a scanner, a computer-readable code associated with a supply of the material, wherein the computer-readable code comprises one or more of: an optical code, and a radio-frequency code.

6. The method of claim 1, wherein the material to be labeled is a medicinal substance, and the label content further comprises at least one of:
a concentration of the medicinal substance,
a dilution of the medicinal substance and a diluent used to dilute the medicinal substance;
a date on which the medicinal substance to be labeled was prepared
an expiration date of the medicinal substance to be labeled;
an identification of an individual who prepared the medical substance to be labeled; and
a warning about a risk associated with the medicinal substance.

7. The method of claim 1, wherein the material is a medicinal substance and the label content further comprises all of:
a concentration of the medicinal substance,
a dilution of the medicinal substance and a diluent used to dilute the medicinal substance;
a date on which the medicinal substance to be labeled was prepared
an expiration date of the medicinal substance to be labeled; and
an identification of an individual who prepared the medical substance to be labeled.

8. The method of claim 1, wherein the labeling standard is a standard developed by at least one of a trade or professional organization, a healthcare provider, a governing body of the medical field, and a government agency.

9. The method of claim 1 further comprising:
applying a machine-readable code representing the material to be labeled on the label stock for entry of the material to be labeled into a database maintained for a healthcare provider when the machine-readable code is read.

10. The method of claim 1, wherein the label content is printed by a computer printer and occurs automatically at a time when said medicinal substance is being prepared for administration to a patient in response to receiving the identification.

11. A computer terminal for generating a label for identifying a material to be used in a medical application, the computer terminal comprising:
a processor;
a computer-input peripheral for entry of an identification of the material to be labeled;
a printer for printing label content on the label; and
a non-transitory computer-readable medium storing computer-executable instructions that, when executed, control the terminal in performing a method comprising:
receiving an identification of the material to be labeled for use in the medical application;
based on the identification of the material to be labeled in the medical application that is received, printing label content to create the label in compliance with a labeling standard for use in the medical application.

12. The computer terminal of claim 11, wherein the computer-input peripheral comprises a scanner for reading a machine-readable code in a contactless manner, said receiving the identification of the material comprising reading the machine-readable code associated with the material with the scanner.

13. The method of claim 11, wherein the label content further comprises a color corresponding to a color code mandated by the labeling standard, the color to be printed by the printer on label stock when label content is printed.

14. The method of claim 11, wherein the label content is to be printed on label stock that is pre-color-coded with a color mandated by the labeling standard before the label content is printed, and the label content is printed on the label stock that is pre-color-coded.

15. A healthcare facility comprising:
a substantially sterile environment in which a medical procedure is to be performed on a patient;
a computer terminal for generating a label for a material to be labeled for use in a medical application, the computer terminal comprising: a processor, a computer-input peripheral for entry of an identification of the material, a printer for printing label content on the label, and a non-transitory computer-readable medium storing computer-executable instructions that, when executed, control the computer terminal in performing a method comprising:
receiving an identification of the material to be labeled for use in the medical application;
based on the identification of the material to be labeled in the medical application that is received, printing label content to create the label in compliance with a labeling standard for use in the medical application.

16. The healthcare facility of claim 15, wherein the computer terminal is disposed adjacent to, or within the sterile environment.

17. A label generated on-demand for identifying a material for use in a medical application, the label comprising:
a content surface on which label content is printed on-demand, wherein the label content comprises information required by a labeling standard;
an adhesive surface to be applied against the material or a container for storing the material and adhering the label to the material or the container; and
a color code visible when viewing the content surface, said color code being associated with the material to be labeled by the labeling standard for conveying information about the material, wherein the label content and color code render the label compliant with the labeling standard.

18. The label of claim 17, wherein the color code is a computer printed color that is printed onto the content surface by a printer during a process for printing the label content.

19. The label of claim 17, wherein the color code is applied to the label to be visible when viewing the content surface before the label content is printed.
